(19) United States
(12) Patent Application Publication
(10) Pub. No.: US 2021/0219539 A1
(43) Pub. Date: Jul. 22, 2021

(54) MOUSETRAP

(71) Applicant: Bruce Maurice Tucker, Port Chester, NY (US)

(72) Inventor: Bruce Maurice Tucker, Port Chester, NY (US)

(21) Appl. No.: 17/223,288

(22) Filed: Apr. 6, 2021

Related U.S. Application Data
(60) Provisional application No. 63/153,377, filed on Feb. 25, 2021.

(51) Int. Cl. A01M 23/16; A01M 23/00

(52) U.S. Cl. CPC A01M 23/16; A01M 23/005

(57) ABSTRACT

The enclosure and the drawer having openings that form a passage for a mouse to reach into the drawer. The drawer having a sheet of sticky material that holds the mouse in the drawer, wherein the drawer having the immobilized mouse can be withdrawn from the enclosure for disposing of the mouse.

### FIELD OF INVENTION

The present invention relates to a mousetrap, and more particularly, the present invention relates to a mousetrap having a drawer.

### BACKGROUND

Different kinds of Mouse traps are known in the art. Most of the technical advancements related to the mouse traps are generally directed to capturing the mouse. Disposal of the mouse is still a problem. The major drawback with the Known mouse traps is that many times the mouse dies in the trap or may be agonized.

Therefore, a desire is there for a mousetrap that is devoid of the drawbacks of the prior art mouse trap.

### SUMMARY OF THE INVENTION

The principal object of the present invention is therefore directed to a mousetrap that allows the safe disposal of the trapped mouse.

It is another object of the present invention that the mousetrap is economical to manufacture.

It is still another object of the present invention that the mousetrap can have a natural internal ambiance.

It a yet another object of the present invention that the captured mouse is visible easily from outside.

It is a further object of the present invention that the mousetrap is compact.

It is an additional object of the present invention that the mousetrap can be easily cleaned.

In one aspect, disclosed is a mousetrap having an enclosure and a drawer. The enclosure having a front side, a rear, a left, right, top, and bottom sides defining the volume of the enclosure. The front side having a front opening to slidably receive the drawer. Each the left side and the right side having an opening.

In one aspect the drawer includes a base and upstanding front, rear, left, and right walls. Each the left and the right walls are having openings that juxtapose with the two openings of the enclosure when the drawer is held within the enclosure, forming two passages for a mouse to reach into the drawer.

In one aspect, the base is having a sheet of sticky material removable placed on the base of the drawer. The sticky material makes the mouse immobile.

In one aspect, the enclosure and the drawer are made of a transparent material, such as transparent plastic.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of a mousetrap, according to an exemplary embodiment of the present invention.

FIG. 2 is a perspective view of the enclosure, according to an exemplary embodiment of the present invention.

FIG. 3 is a perspective view of the drawer, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

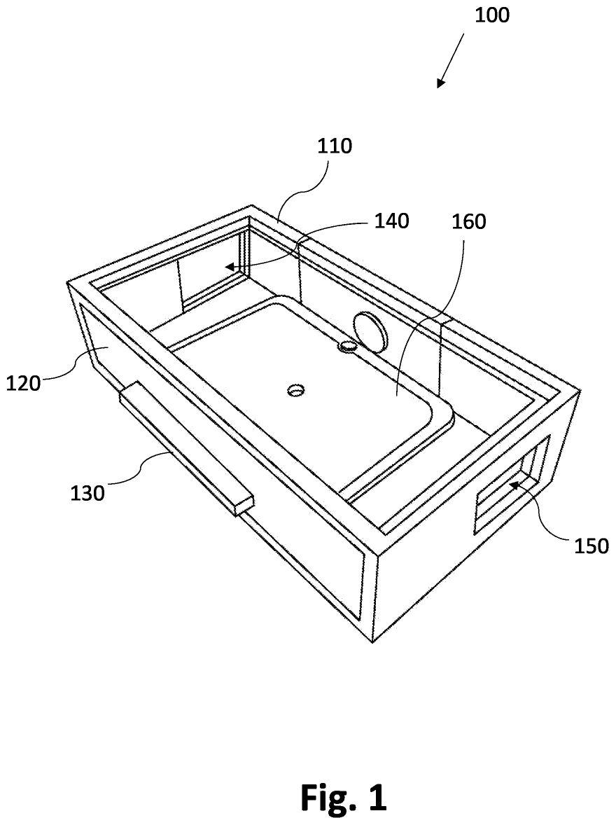

Disclosed is a mousetrap having an enclosure and a drawer slidably received in the enclosure. Referring to FIGS. 1, 2, and 3 which shows the mousetrap, the enclosure, and the drawer. The mousetrap 100 is having an enclosure 110 and a drawer 120. The drawer 120 can be seen within the enclosure 120. The drawer can be slidably received into the enclosure and withdrawn from the enclosure. The drawer 120 can have a handle 130 to pull the drawer. A first passage 140 can be seen on left of the mousetrap 100 which can be sized to permit a mouse to get into the drawer 120. A similar second passage 150 can also be seen on the right side. A mouse can enter the mouse trap from either the left or right side. It is to be understood that the mousetrap can have one or more passages for the mouse, without departing from the scope of the present invention. Additionally, a glue sheet 160 can also be seen in FIG. 1, which can hold the mouse immobile and prevent it from leaving the mousetrap 100.

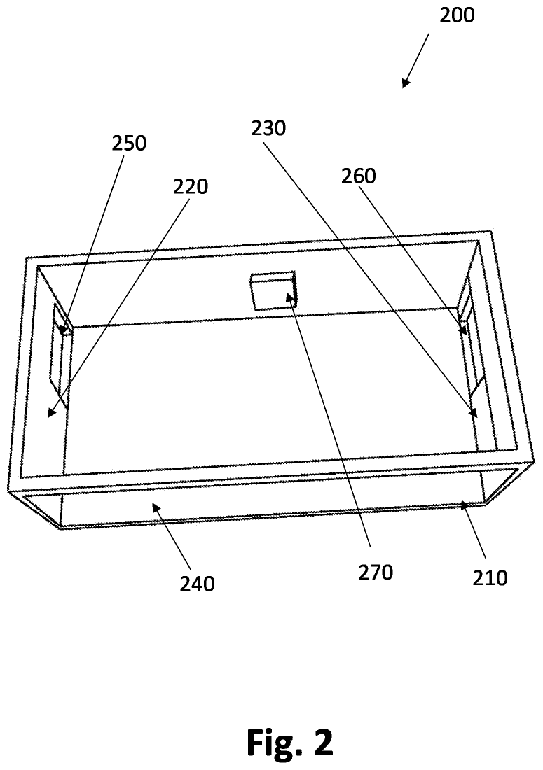

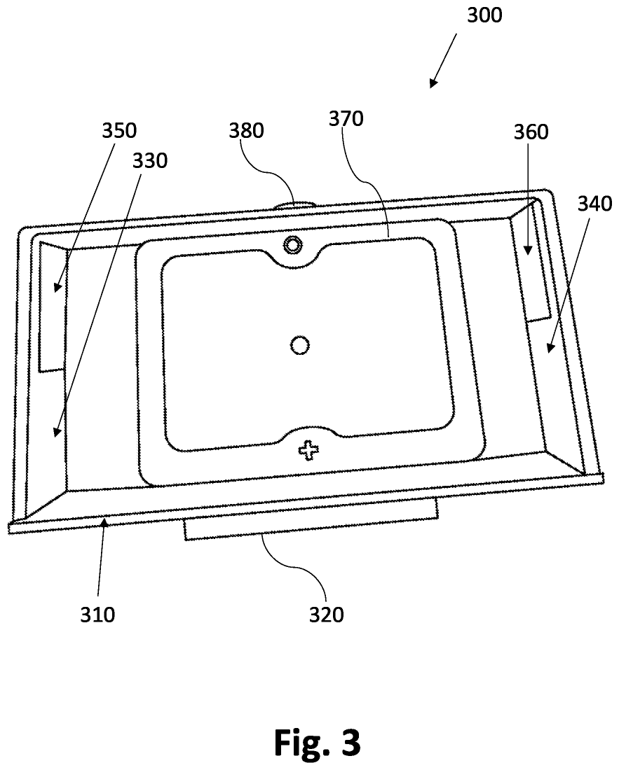

Referring to FIG. 2, which shows the enclosure 200 having a front side 210, a rear side, a left side 220, a right side 230, a top side, and a bottom side define the volume of the enclosure 200. The front side 210 can have a front opening 240 for slidably receiving the drawer 300 (shown in FIG. 3). The left side 220 of enclosure 200 can have a first opening 250 and the right side 230 can have a second opening 260. The size of the first opening 250 and the second opening 260 can be big enough to permit a mouse to pass through into the interior of the mouse trap i.e., the drawer. Additionally, an aperture 270 can be seen on the rear side of the enclosure.

Referring to FIG. 3, which shows an exemplary embodiment of the drawer 300 can have a base and four upstanding walls including the left, right, front, and rear walls. The top is open. The front wall 310 can have a handle 320 for pulling the drawer 300. Each the left wall 330 and the right wall 440 can also have openings 350 and 360 respectfully. The enclosure's openings 250 and 260 are positioned to juxtapose with the drawer's openings 350 and 360 respectively, when drawer 300 is held within the enclosure 200. The two openings of the enclosure and the two openings of the drawer form the two passages (shown in FIG. 1) for a mouse to reach into the drawer 200.

On the base of the drawer 300 can be placed a sheet 370 of sticky material which can make a mouse landing on the sheet 370 immobile. Compositions of such sticky material for holding a mouse immobile are known in the art. A protrusion 380 on the rear wall of the drawer can engage with the aperture 270 on the rear side of the enclosure 200.

A mouse can enter the interior of the drawer from either of the two passages. Once the mouse lands on the glue sheet, the sticky material can hold the mouse and prevent it from leaving the enclosure. A user can withdraw the drawer through the handle of the drawer. Once the drawer is withdrawn from the enclosure, the mouse can be disposed of safely. Thereafter, a new glue sheet can be placed in the drawer and the drawer can be slid back into the enclosure.

The enclosure and the drawer both can be made from transparent material, such as the trapped mouse is easily visible from the outside. Moreover, the internal environment of the mousetrap can have a natural ambiance.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A mouse trap comprising an enclosure and a drawer,
the enclosure comprises:
a front side, a rear side, a left side, a right side, a top side, and a bottom side defining an inner volume of the enclosure,
the front side having a front opening for slidably receiving the drawer,
the left side having a first opening dimensioned to permit a mouse to pass through,
the drawer comprises:
a base and an upstanding front wall, rear wall, left wall, and a right wall,
the left wall having a second opening, wherein the second opening and the first opening are positioned to juxtapose when the drawer is within the enclosure, wherein the first opening and the second opening forms a first passage for the mouse to get into the drawer.

2. The mousetrap according to claim 1, wherein the right side of the enclosure is having a third opening dimensioned to permit the mouse to pass-through, the right wall of the drawer is having a fourth opening, wherein the third opening and the fourth opening are positioned to juxtapose when the drawer is within the enclosure, wherein the third opening and the fourth opening forms a second passage for the mouse to get into the drawer.

3. The mousetrap according to claim 1, wherein the front wall is having a handle for pulling the drawer.

4. The mousetrap according to claim 1, wherein the enclosure and the drawer are transparent.

5. The mousetrap according to claim 1, wherein the mousetrap further comprises a sheet of sticky material removably placed on the base of the drawer.
